(19) United States
(12) Patent Application Publication
(10) Pub. No.: US 2004/0103086 A1
(43) Pub. Date: May 27, 2004

(54) Data structure traversal instructions for packet processing

(76) Inventors: Bapiraju Vinnakota, Freemont, CA (US); Carl A. Alberola, Fremont, CA (US); Saleem Mohammadali, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/304,362

(22) Filed: Nov. 26, 2002

(51) Int. Cl. G06F 7/00

(52) U.S. Cl. 707/3

(57) ABSTRACT

Embodiments of the invention relate to data structure traversal instructions that perform efficient data structure traversal operations in packet processing applications. In one embodiment, a data structure traversal instruction for use in packet processing includes a control. In response to the control, the data structure traversal instruction accesses at least one node of a data structure. The data structure is typically a linked list or a binary tree. In an exemplary environment, the data structure traversal instruction may be implemented by a packet processor core of packet processor in a network device. In particular, three data structure traversal instructions are disclosed for accessing a node in a linked list and returning a data field, searching for a key value in a node of linked list, and accessing a node in a binary tree and searching for a matching key value, respectively.

### BACKGROUND

1. Field of the Invention

Embodiments of the invention relate to the field of instruction sets. More particularly, embodiments of the invention relate to data structure traversal instructions for packet processing.

2. Description of Related Art

Microprocessors have instruction sets called microcode that programmers use to create low-level computer programs. The instruction sets perform various tasks, such as moving values into registers or executing instructions to add the values in registers. Microcode can be either simple or complex, depending on the microprocessor manufacturer's preference and the intended use of the chip.

Traditional Reduced Instruction Set Computer (RISC) designs, as the name implies, have a reduced set of instructions that improve the efficiency of the processor, but also require more complex external programming. Particularly, traditional RISC based computer architecture reduces processor complexity by using simpler instructions and a reduced set of instructions. In traditional RISC architectures, the microcode layer and associated overhead is eliminated. Moreover, traditional RISC architectures keep instruction size constant, ban indirect addressing modes and retain only those instructions that can be overlapped and made to execute in one machine cycle or less.

By using traditional RISC designs that include simple instructions and control flow, hardware size can be minimized and clock speed can be increased. When designing an instruction set for a specific application, a traditional RISC instruction set can be augmented by instructions that accelerate the functionality needed for the particular application. These instructions can be particularly tailored to improve performance by reducing the number of cycles needed for operations commonly used in the target application, while attempting to preserve the clock speed.

For example, packet processing for voice applications generally requires the manipulation of several layers of protocol headers and several types of protocols such as IP, ATM and ATM adaptation layers (AALs). Network devices are typically assigned specific addresses and port numbers to identify the source and destination. Generally, look up tables and any state information that needs to be maintained for the different voice flows are stored in complex data structures in memory. However, RISC instructions typically only operate on bytes or words (e.g. 2 or 4 bytes) of data and only support simple memory operations like loads and stores. Unfortunately, traversing data structures is complex and inneficient using traditional RISC instructions.

### BRIEF DESCRIPTION OF THE DRAWINGS

FIG. 1 shows an illustrative example of a voice and data communications system.

FIG. 2 is a simplified block diagram illustrating a multi-service access device in which embodiments of the present invention can be practiced.

FIG. 3 is a simplified block diagram illustrating an example of a packet processing card in which embodiments of the present invention can be practiced.

FIG. 4 is a simplified block diagram illustrating an example of a packet processor in which embodiments of the present invention can be practiced.

FIG. 5 illustrates a process for implementing a data structure traversal instruction according to one embodiment of the present invention.

FIG. 6 shows a plurality of source operand registers and destination operand registers, which may be utilized in implementing embodiments of the present invention.

FIG. 7 provides a table of data structure traversal (DST) instructions for a DST instruction set architecture (DST ISA), and a short description of each instruction, according to embodiments of the invention.

FIG. 8A illustrates a PNTR (i.e. pointer) instruction, of the data structure traversal ISA, according to one embodiment of the invention.

FIG. 8B shows an example of an implementation of the PNTR (i.e. pointer) instruction, according to one embodiment of the invention.

FIG. 9A illustrates a LSRC (i.e. link search) instruction, of the data structure traversal ISA, according to one embodiment of the invention.

FIG. 9B shows an example of an implementation of the LSRC (i.e. link search) instruction, according to one embodiment of the invention.

FIG. 10A illustrates a TREE (i.e. tree search) instruction, of the data structure traversal ISA, according to one embodiment of the invention.

FIG. 10B shows an example of an implementation of the TREE (i.e. tree search) instruction, according to one embodiment of the invention.

### DESCRIPTION

In the following description, the various embodiments of the present invention will be described in detail. However, such details are included to facilitate understanding of the invention and to describe exemplary embodiments for employing the invention. Such details should not be used to limit the invention to the particular embodiments described because other variations and embodiments are possible while staying within the scope of the invention. Furthermore, although numerous details are set forth in order to provide a thorough understanding of the present invention, it will be apparent to one skilled in the art that these specific details are not required in order to practice the present invention. In other instances details such as, well-known methods, types of data, protocols, procedures, components, networking equipment, electrical structures and circuits, are not described in detail, or are shown in block diagram form, in order not to obscure embodiments of the present invention. Furthermore, aspects of the invention will be described in particular embodiments but may be implemented in hardware, software, firmware, middleware, or a combination thereof.

In the following description, certain terminology is used to describe various environments in which embodiments of the present invention can be practiced. In general, a “communication system” comprises one or more end nodes having connections to one or more networking devices of a network. More specifically, a “networking device” comprises hardware and/or software used to transfer information through a network. Examples of a networking device include a multi-access service device, a router, a switch, a repeater, or any other device that facilitates the forwarding of information. An “end node” normally comprises a combination of hardware and/or software that constitutes the source or destination of the information. Examples of an end node include a switch utilized in the Public Switched Telephone Network (PSTN), Local Area Network (LAN), Private Branch Exchange (PBX), telephone, fax machine, video source, computer, printer, workstation, application server, set-top box and the like. “Data traffic” generally comprises one or more signals having one or more bits of data, address, control, or any combination thereof transmitted in accordance with any chosen packeting scheme. Particularly, “data traffic” can be data, voice, address, and/or control in any representative signaling format or protocol. A “link” is broadly defined as one or more physical or virtual information carrying mediums that establish a communication pathway such as, for example, optical fiber, electrical wire, cable, bus traces, wireless channels (e.g. radio, satellite frequency, etc.) and the like.

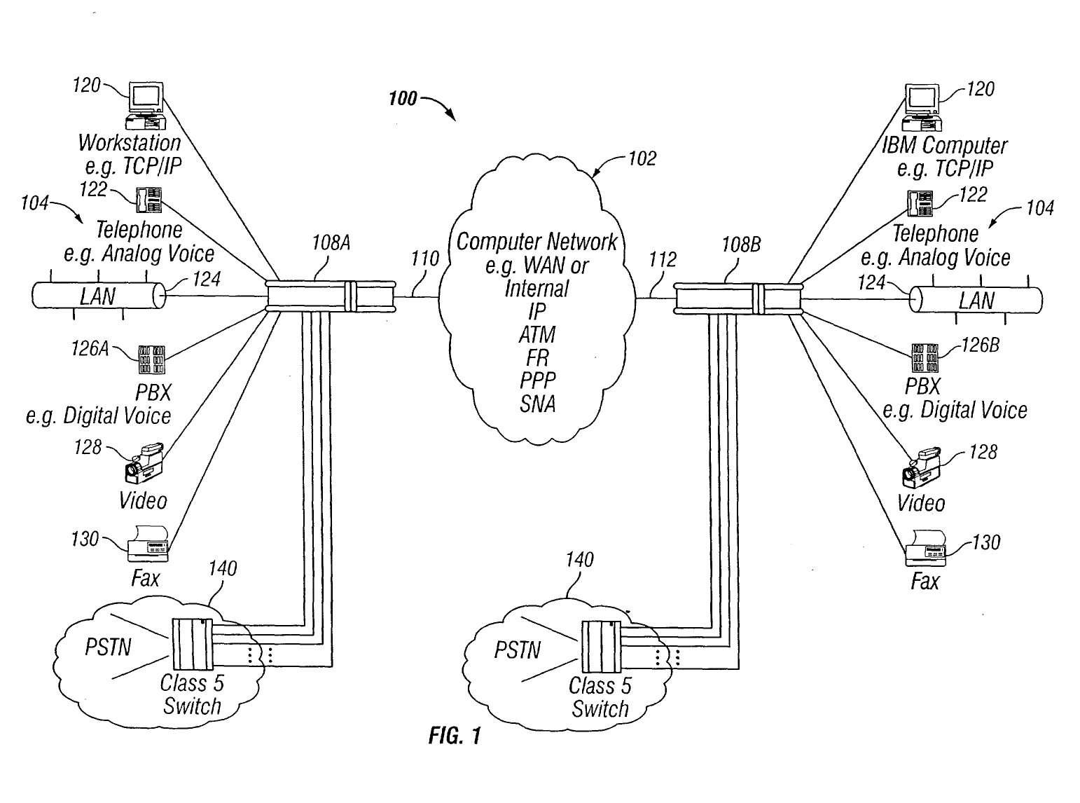

FIG. 1 shows an illustrative example of a voice and data communications system 100. The communication system 100 includes a computer network (e.g. a wide area network (WAN) or the Internet) 102 which is a packetized or a packet-switched network that can utilize Internet Protocol (IP), Asynchronous Transfer Mode (ATM), Frame Relay (FR), Point-to Point Protocol (PPP), Systems Network Architecture (SNA), or any other sort of protocol. The computer network 102 allows the communication of data traffic, e.g. voice/speech data and other types of data, between any end nodes 104 in the communication system 100 using packets. Data traffic through the network may be of any type including voice, graphics, video, audio, e-mail, fax, text, multi-media, documents and other generic forms of data. The computer network 102 is typically a data network that may contain switching or routing equipment designed to transfer digital data traffic. At each end of the communication system 100 the voice and data traffic requires packetization when transceived across the network 102.

The communication system 100 includes networking devices, such as multi-service access devices 108A and 108B, in order to packetize data traffic for transmission across the computer network 102. A multi-service access device 108 is a device for connecting multiple networks (e.g. a first network to a second network) and devices that use different protocols and also generally includes switching and routing functions. Access devices 108A and 108B are coupled together by network links 110 and 112 to the computer network 102.

Voice traffic and data traffic may be provided to a multi-service access device 108 from a number of different end nodes 104 in a variety of digital and analog formats. For example, in the exemplary environment shown in FIG. 1, the different end nodes include a class 5 switch 140 utilized as part of the PSTN, computer/workstation 120, a telephone 122, a LAN 124, a PBX 126, a video source 128, and a fax machine 130 connected via links to the access devices. However, it should be appreciated any number of different types of end nodes can be connected via links to the access devices. In the communication system 100, digital voice, fax, and modem traffic are transceived at PBXs 126A, 126B, and switch 140, which can be coupled to multiple analog or digital telephones, fax machines, or data modems (not shown). Particularly, the digital voice traffic can be transceived with access devices 108A and 108B, respectively, over the computer packet network 102. Moreover, other data traffic from the other end nodes: computer/workstation 120 (e.g. TCP/IP traffic), LAN 124, and video 128, can be transceived with access devices 108A and 108B, respectively, over the computer packet network 102.

Also, analog voice and fax signals from telephone 122 and fax machine 130 can be transceived with multi-service access devices 108A and 108B, respectively, over the computer packet network 102. The access devices 108 convert the analog voice and fax signals to voice/fax digital data traffic, assemble the voice/fax digital data traffic into packets, and send the packets over the computer packet network 102.

Thus, packetized data traffic in general, and packetized voice traffic in particular, can be transceived with multi-service access devices 108A and 108B, respectively, over the computer packet network 102. Generally, an access device 108 packetizes the information received from a source end node 104 for transmission across the computer packet network 102. Usually, each packet contains the target address, which is used to direct the packet through the computer network to its intended destination end node. Once the packet enters the computer network 102, any number of networking protocols, such as TCP/IP, ATM, FR, PPP, SNA, etc., can be employed to carry the packet to its intended destination end node 104. The packets are generally sent from a source access device to a destination access device over virtual paths or a connection established between the access devices. The access devices are usually responsible for negotiating and establishing the virtual paths or connections. Data and voice traffic received by the access devices from the computer network are depacketized and decoded for distribution to the appropriate destination end node. It should be appreciated that the FIG. 1 environment is only an exemplary illustration to show how various types of end nodes can be connected to access devices and that embodiments of the present invention can be used with any type of end nodes, network devices, computer networks, and protocols.

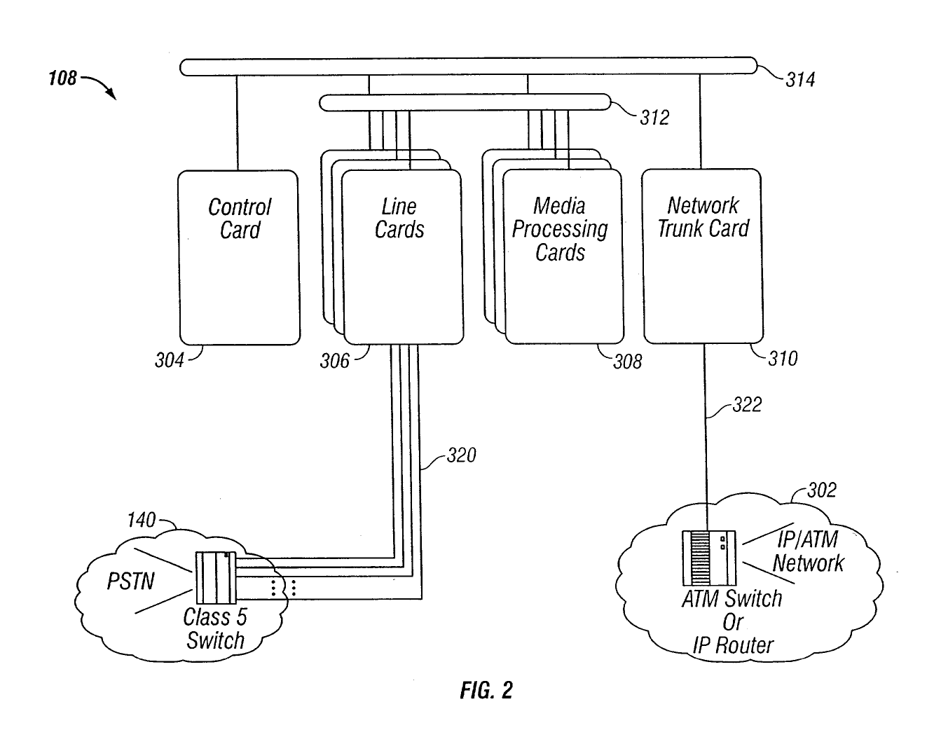

FIG. 2 is a simplified block diagram illustrating a multi-service access device 108 in which embodiments of the present invention can be practiced. As shown in FIG. 2, the conventional multi-service access device 108 includes a control card 304, a plurality of line cards 306, a plurality of media processing cards 308, and a network trunk card 310. Continuing with the example of FIG. 1, the switch 140 can be connected to the multi-service access device 108 by connecting cables into the line cards 306, respectively. On the other side, the network trunk card 310 can connect the multi-service access device 108 to the computer network 102 (e.g. the Internet) through an ATM switch or IP router 302. All of the various cards in this exemplary architecture can be connected through standard buses. As an example, all of the cards 304, 306, 308, and 310, are connected to one another through a Peripheral Component Interconnect (PCI) bus 314. The PCI bus 314 connects the network trunk card 310 to the media processing cards 308 and carries the packetized traffic and/or control and supervisory messages from the control card 304. Also, the line cards 306 and the media processing cards 308 are particularly connected to one another through a bus 312. The bus 312 can be a Time Division Multiplexing (TDM) bus (e.g. an H. 110 computer telephony bus) that carries the individual timeslots from the line cards 306 to the media processing cards 308.

In this example, the multi-service access device 108 can act as a Voice over Packet (VoP) gateway to interface a digital TDM switch 140 on the PSTN side to a router or ATM switch 302 on the IP/ATM side. The connection to the TDM switch may be a group of multiple T1/E1/J1 cable links 320 forming a GR-303 or V5 .2 interface whereas the IP/ATM interface may be a Digital Signal Level 3 (DS3) or Optical Carrier Level 3(OC-3) cable link 322 or higher. Thus, in this example, the multi-service access device 108 can perform the functions of providing voice over a computer network, such as the Internet.

Looking particularly at the cards, the control card 304 typically acts as a supervisory element responsible for centralized functions such as configuring the other cards, monitoring system performance, and provisioning. Functions such as signaling, gateway, or link control may also reside in this card. It is not uncommon for systems to offer redundant control cards given the critical nature of the functions they perform. As to the media processing cards 308, as the name indicates, these cards are responsible for processing media- e.g. voice traffic. This includes tasks such as timeslot switching, voice compression, echo canceling, comfort noise generation, etc. Packetization of the voice traffic may also reside in this card. The network trunk card 310 contains the elements needed to interface to the packet network. The network trunk card 310 maps the network packet (cells) into a layer one physical interface such as DS-3 or OC-3 for transport over the network backbone. As to the line cards 306, these cards form the physical interface to the multiple T1/E1/J1 cable links 320. These cards provide access to the individual voice timeslots and to the “control” channels in a GR-303 or V5 .2 interface. The line cards 306 also provide access to the TDM signaling mechanism.

It should be appreciated that this is a simplified example of a multi-service access device 108 used to highlight aspects of embodiments of the present invention for data structure traversal (DST) instructions for packet processing, as will be discussed. Furthermore, it should be appreciated that other generally known types of networking devices, multi-service access devices, routers, gateways, switches, wireless base stations etc., that are known in the art, can just as easily be used with embodiments of the present invention for data structure traversal (DST) instructions for packet processing.

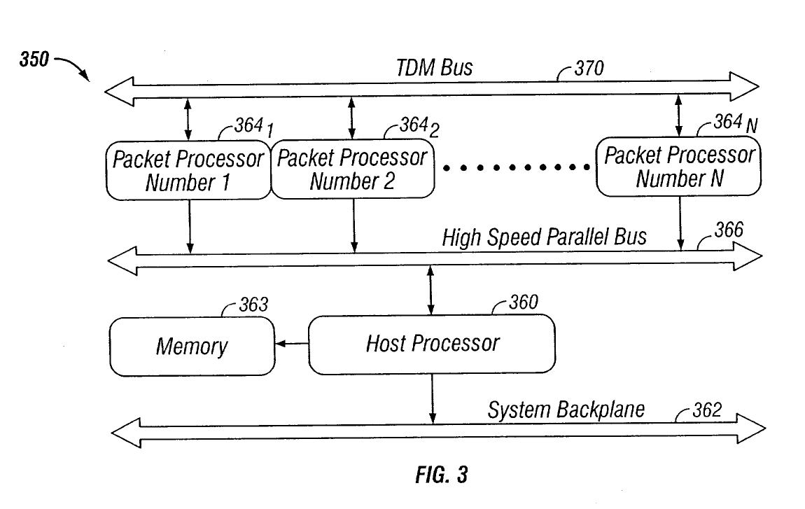

FIG. 3 is a simplified block diagram illustrating an example of a packet processing card 350 in which embodiments of the present invention can be practiced. The packet processing card 350 can be one of the media processing cards 308 or part of one of the media processing cards 308. In one example, the packet processing card 350 can be a voice processing card that performs TDM-to-packet interworking functions that involve Digital Signal Processing (DSP) functions on payload data, followed by packetization, header processing, and aggregation to create a high-speed packet stream.

In the voice processing example, the voice processing functionality can be split into control-plane and data-plane functions, which have different requirements. For example, the control-plane functions include board and device management, command interpretation, call control and signaling conversation, and messaging to call-management servers. The data-plane functions are provided by the bearer channel (which carries all the voice and data traffic) which include all TDM-to-packet processing functions: DSP, packet processing, header processing, etc.

FIG. 3 illustrates a packet processing card 350 having a host processor 360 (e.g. an aggregation engine) connected to a system backplane 362, a memory 363, and a high-speed parallel bus 366. The host processor 360 is connected to a plurality of packet processors 364_{1-N} by the high-speed parallel bus 366. The packet processors 364_{1-N} are further connected to a bus 370 (e.g. a TDM bus). The packet processors 364_{1-N}, in one example, can be considered to be DSP devices that generate protocol data unit (PDU) traffic. The packet processing card 350 has a centralized memory 363 for packet buffering and streaming over the packet interface to the switched fabric or packet backplanes. The memory 363 being located in the packet processing card 350 significantly reduces the memory required on the packet processor 364_{1-N} and eliminates the need for external memory for each packet processor, greatly reducing total power consumption enabling robust scalability and packet processing resources.

FIG. 4 is a simplified block diagram illustrating an example of a packet processor 364 in which embodiments of the present invention can be practiced. As shown in FIG. 4, the packet processor 364 includes all of the functional blocks necessary to interface with various network devices and buses to enable packet and voice processing subsystems. In this example, the packet processor 364 includes four packet processor cores 402₁₋₄. However, four packet processor cores 402₁₋₄ are only given as an example, and it should be appreciated that any number of packet processor cores can be utilized. The packet processor cores 402₁₋₄ execute algorithms needed to process protocol packets. Moreover, dedicated local data memory 404₁₋₄ and dedicated local program memory 406₁₋₄ are coupled to each packet processor core 402₁₋₄, respectively. A high-speed internal bus 410 and distributed DMA controllers provide the packet processor cores 402₁₋₄ with access to data in a global memory 412. At one end, the packet processor 364 includes an external memory interface port 416 connected to the high-speed internal bus 410 for access to external memory. At the other end, the packet processor 364 includes a multiple packet bus interface 418 connected to the high-speed internal bus 410. For example, the packet bus interface 418 can be a 32-bit parallel host bus interface for transferring voice packet data and programming the device. Further, the packet bus interface 418 may be a standard interface such as a PCI interface or a Utopia Interface. The packet processor 364 further includes a control processor core 420 (e.g. a RISC based control processor) coupled to an instruction cache 422 and a data cache 424, which are all coupled to the high-speed internal bus 410. The control processor core 420 schedules tasks and manages data flows for the packet processor cores 402₁₋₄ and manages communication with an external host processor. Thus, in addition to the packet processor cores 402₁₋₄, the packet processor 364 includes a RISC based control processor core 420, which manages communication between a system host processor and within the packet processor 364 itself. The control processor core 420 is responsible for scheduling and managing flows of incoming data to one of the packet processor cores 402₁₋₄ and invoking the appropriate program on that packet processing core for processing data. This architecture allows the packet processor cores to concentrate on processing data flows, thus achieving high packet processor core utilization in computational performance. It also eliminates bottlenecks that would occur when the system is scaled upward if all the control processing had to be handled at higher levels in the system.

Furthermore, each packet processor core 402 includes a RISC instruction set architecture (ISA) 430 that is used in conjunction with a data structure traversal (DST) instruction set architecture (DST ISA) 434, according to embodiments of the invention. The data structure traversal ISA 434 can be utilized by the packet processor core 402 to perform effective data structure traversal operations for packet processing applications. Also, the host processor 360 of the packet processing card 350 may also utilize the data structure traversal ISA, according to embodiments of the invention. The RISC instruction set architecture (ISA) 430 and the data structure traversal (DST) instruction set architecture (DST ISA) 434, or portions thereof, may be stored in the packet processor core 402 itself, in program memory 406, or at other locations. The data structure traversal ISA 434 will be discussed in detail in the following sections.

It should be appreciated that although the example network environment 100 was shown in FIG. 1, the example of a multi-service access device 108 was shown in FIG. 2, the example of a packet processing card 350 was shown in FIG. 3, and the example of a packet processor 364 was shown in FIG. 4, that these are only examples of environments (e.g. packet processing cards, packet processors, and network devices) that the data structure traversal (DST) instructions according to embodiments of the invention can be used with. Further, it should be appreciated that the data structure traversal (DST) instructions for packet processing according to embodiments of the invention can be implemented in a wide variety of packet processing cards, packet processors, and known network devices—such as other types of multi-service access devices, routers, switches, wireless base stations, ATM gateways, frame relay access devices, purely computer based networks (e.g. for non-voice digital data), other types of voice gateways and combined voice and data networks, etc., and that the previous described multi-service access device and VoP environment is only given as an example to aid in illustrating one potential environment for the data structure traversal (DST) instructions according to embodiments of the invention, as will now be discussed.

Further, those skilled in the art will recognize that the exemplary environments illustrated in FIGS. 1-4 are not intended to limit the present invention. Moreover, while aspects of the invention and various functional components have and will be described in particular embodiments, it should be appreciated these aspects and functionalities can be implemented in hardware, software, firmware, middleware or a combination thereof.

Embodiments of the invention relate to novel and nonobvious data structure traversal instructions that perform efficient data structure traversal operations for packet processing applications. In one embodiment, a data structure traversal instruction for use in packet processing includes a control. In response to the control, the data structure traversal instruction traverses a data structure to access at least one node of the data structure. The data structure is typically a linked list or a binary tree. As previously discussed, in an exemplary environment, the data structure traversal instructions (i.e. an instruction set architecture (ISA)) may be implemented by a packet processor core of packet processor in a network device. In particular, three data structure traversal instructions are disclosed for accessing a node in a linked list and returning a data field, searching for a key value in a node of linked list, and accessing a node in a binary tree and searching for a matching key value, respectively.

In particular, the three new instructions that are disclosed are particularly tailored to traversing data structures such as linked lists and binary trees that are commonly found in packet processing applications. These instructions are particularly useful for packet processing applications. It should be noted that the instructions to be hereinafter discussed do not perform arithmetic operations on the values being read/written.

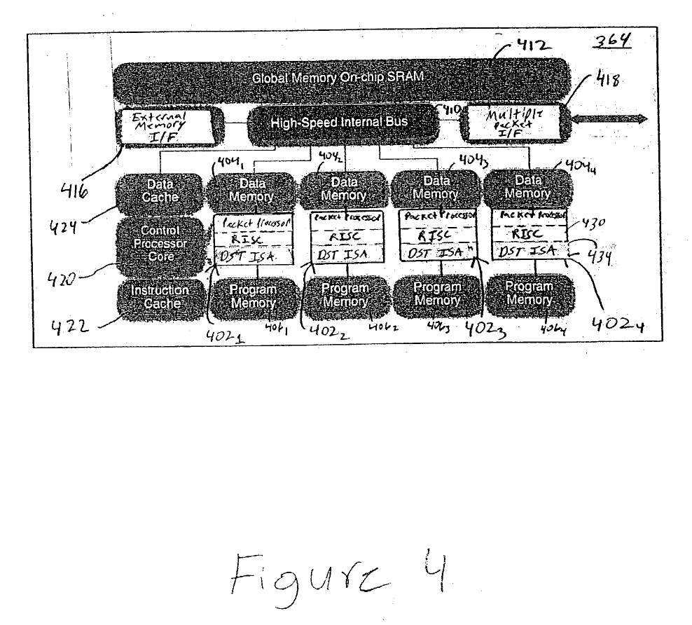

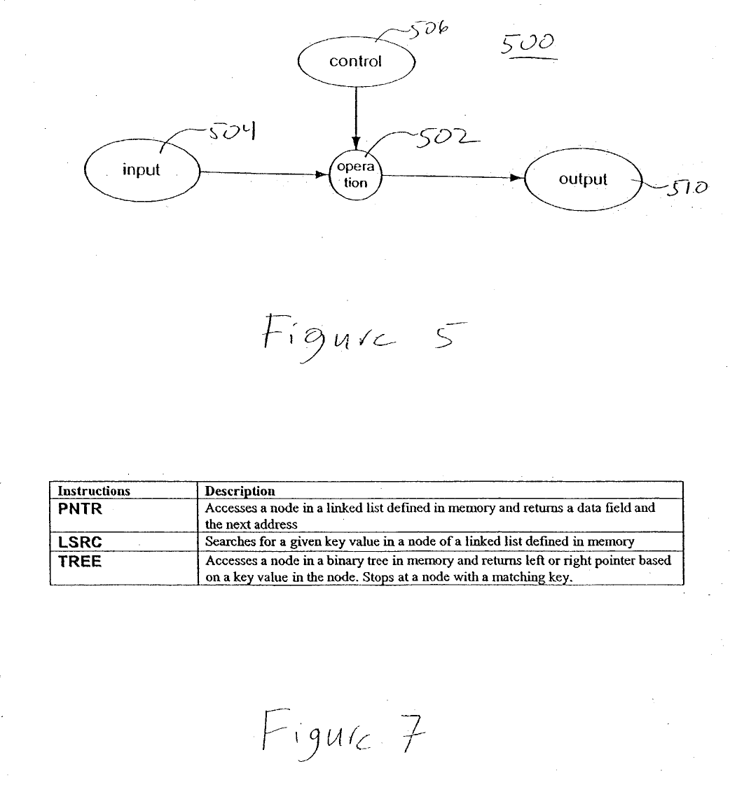

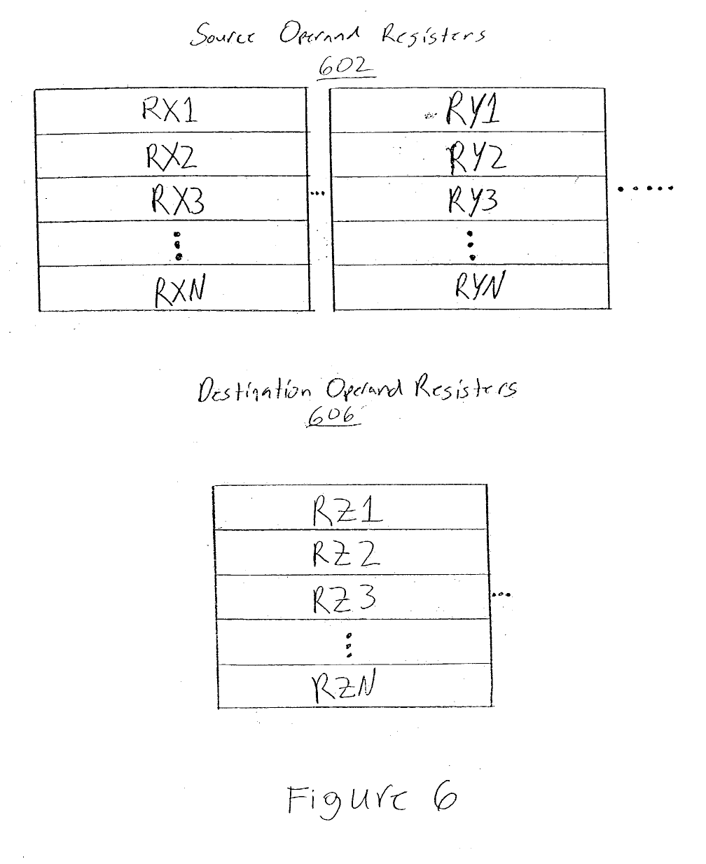

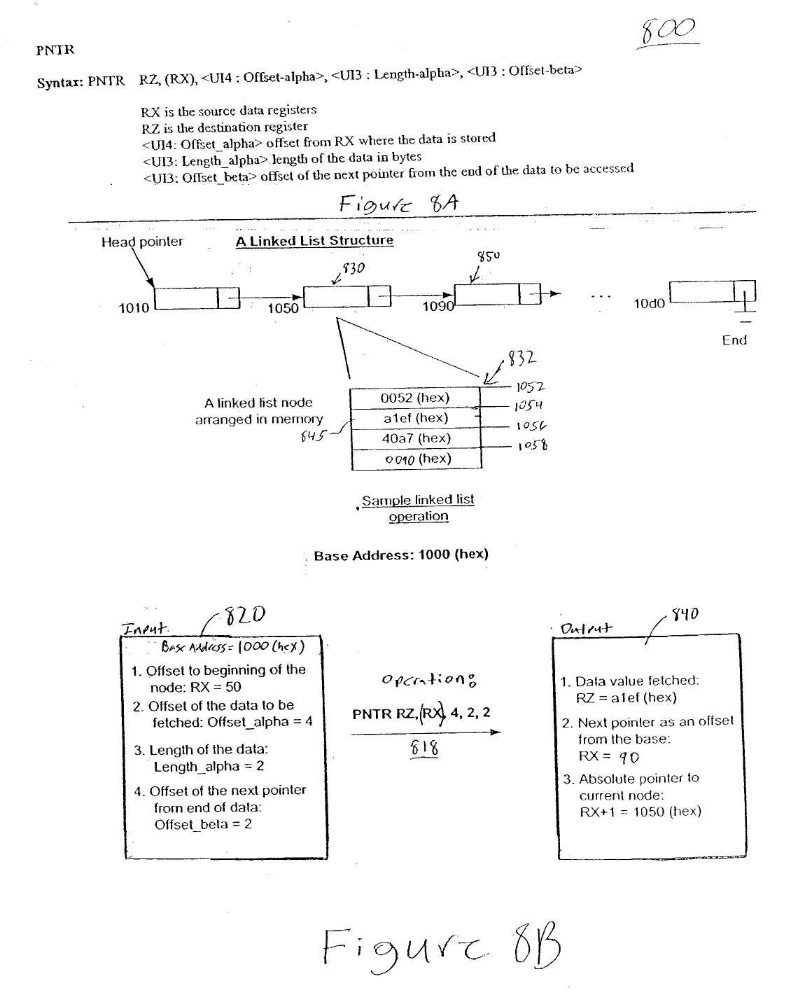

With reference now to FIG. 5, FIG. 5 illustrates a process 500 for implementing a data structure traversal instruction according to one embodiment of the present invention. Particularly, FIG. 5 shows that during an operation 502 that input data 504 is combined with a control 506 such that output data 510 is yielded. More particularly, with reference also to FIG. 6, FIG. 6 shows a plurality of source operand registers and destination operand registers, which may be utilized in implementing embodiments of the present invention.

In one embodiment, input data 504 such as source operands may be drawn from a plurality of registers. In the present example, source operands may be drawn from upto four registers. For example, with reference also to FIG. 6, source operands may come from source operand data register 602. As will be described in the examplary syntax descriptions that will follow, and as shown in FIG. 6, the source operand data register 602 may store source operands referred to as RX1, RX2, RX3. RXN; RY1, RY2, RY3. RYN; . . . etc. However, it should be appreciated that the source operands may come from different registers. Further, it should be appreciated that this is only an example of a source operand data register.

Continuing with the present example, in one embodiment, output data 504 such as destination operands may be directed to a plurality of registers. In the present example, destination operands may be directed to upto four registers. For example, as shown in FIG. 6, destination operands may be directed to a plurality of destination operand data registers 606. As will be described in the exemplary syntax descriptions that will follow, and as shown in FIG. 6, the destination operand data register 606 may store destination operands referred to as RZ1, . . . RZ3. RZN; . . . etc. It should be appreciated that this is only an example of a destination operand data register.

The control 506 for an instruction is typically embedded in the instruction itself and/or sourced from control registers. For example, when the control 506 is sourced from control registers, the registers with control data are either identified in the instruction or the control data is sourced from standard control registers. Although the need to set up an additional register may appear to be a computational burden, it is likely that the same set of data structure traversal operations are performed on every packet received across all flows. Therefore, the pattern needed can be created once and stored in memory. The pattern can then be downloaded when needed and used on different data values. This avoids the need to re-create the control register dynamically.

Certain notation will now be defined, and will be discussed in more detial in the following detailed discussion of the instructions. For example, in the case where the control is embedded in the instruction itself, it specified by optional parameters. Parameters specified in [ ] indicate optional specification, as will be discussed. The notation A/B specifies that either A or B can be specified, not both. Also, UI refers to unsigned integer and SI refers to signed integer. A[n:m] represents bits included between n and m, both inclusive, where n>=m. The notation { } indicates a concatenation of operands specified inside { }. Further, using parentheses around a register specifier, such as (RX), implies that the register RX contains a memory address and the operation needs to be performed on the content of the memory location rather than the data in the register itself.

Before the detailed discussion of the instructions of the data structure traversal ISA is presented, a short overview of each instruction will be provided with reference to FIG. 7. FIG. 7 provides a table of the data structure traversal instructions and a short description of each instruction, according to embodiments of the invention. Particularly, as shown in FIG. 7, the PNTR (i.e. pointer) instruction is used to access a node in a linked list defined in memory and to return a data field and the next address. The LSRC (i.e. link search) instruction searches for a given key value in a node of a linked list defined in memory. The TREE (i.e. tree search) instruction is used to access a node in a binary tree in memory and to return a left or right pointer based on a key value in the node and further stops at a node with a matching key. Now, moving onto a detailed description of each instruction, the PNTR (i.e. pointer) instruction will be discussed. It should be noted that, unless otherwise specified, the numbers in the following examples of the data structure traversal instructions are in hexadecimal.

Turning now to FIG. 8A, FIG. 8A illustrates a PNTR (i.e. pointer) instruction 800 of the data structure traversal ISA according to one embodiment of the invention. Basically, the PNTR (i.e. pointer) instruction 800 is used to access a node in a linked list defined in memory and to return a data field and the next address. As shown in FIG. 8A, The PNTR instruction 800 has the following syntax: PNTR RZ, (RX), <UI4: Offset-alpha>, <UI3: Length-alpha>, <UI3: Offset-beta>; where:

RX is the source data register;

RZ is the destination register;

<UI4: Offset_alpha> is the offset from RX where the data is stored;

<UI3: Length_alpha> is the length of the data in bytes; and

<UI3: Offset_beta> is the offset of the next pointer from the end of the data to be accessed.

Generally, the PNTR (i.e. pointer) instruction 800 takes as input, an address to a node of a linked list defined in memory and returns a data member of the node, an address to the next node, and also the current pointer. The <UI4: Offset_alpha>, <UI3: Length-alpha>, and <UI3: Offset-beta> parameters may be considered control parameters. Further, the addresses are usually defined as an offset from a base address, which is stored in a control register. This helps in easy relocation of the entire linked list in that the node contents can be copied over to a different area in memory and the base register can be modified to point to the new location. This relocation does not require modifying the next pointers stored in the linked list nodes.

Particularly, looking at FIG. 8B, the PNTR (i.e. pointer) instruction operation: PNTR RZ, RX, 4, 2, 2 (818) will be discussed, as an example. The inputs (block 820) are defined as follows: the base address is defined to be 1000, the offset to the beginning of the node is defined as (RX)=50 (i.e. node address=1050) (block 830); the offset of the data to be fetched is 4 (i.e. Offset_alpha=4); the length of the data in bytes is 2 (i.e. Length_alpha=2); and the offset of the next pointer from the end of the data is 2 (i.e. Offset_beta=2). The PNTR instruction operation 818 with the previously described inputs returns outputs (block 840), including: the 2 byte data value fetched starting at address 1054 RZ=alef (block 845); the 2 byte next pointer as an offset from the base fetched starting at address 1058 RX=90 (i.e. pointer 1090, block 850); and the absolute pointer to the current node, RX+l=1050 (block 830).

Further, it should be noted that an offset of zero is used to indicate the end of the list. When the instruction is supplied with an initial pointer offset of zero, it behaves like a null instruction and does nothing. This helps in using the instruction in a loop effectively.

The following is an example in pseudo code showing how to use the PNTR (i.e. pointer) instruction in a loop to traverse a complete linked list:

| Initialize base pointer | |
|---|---|
| RX = offset to first node | |
| While (RX != 0) | |
| { | /* This loop increments the key in every node of the linked list */ |

PNTR RZ, (RX), 4, 2, 2
Increment RZ
Store RZ at (RX+1) /* note that RX+1 contains absolute pointer to

current node */

}

Moreover, the previously described PNTR (i.e. pointer) instruction, used to access a node in a linked list defined in memory and to return a data field and the next address, is very useful for packet processing applications. In particular, the PNTR instruction executes with one cycle throughput. In comparison, utilizing a traditional RISC instruction set, the number of cycles needed to perform the same pointer functionality is around 5-8 cycles.

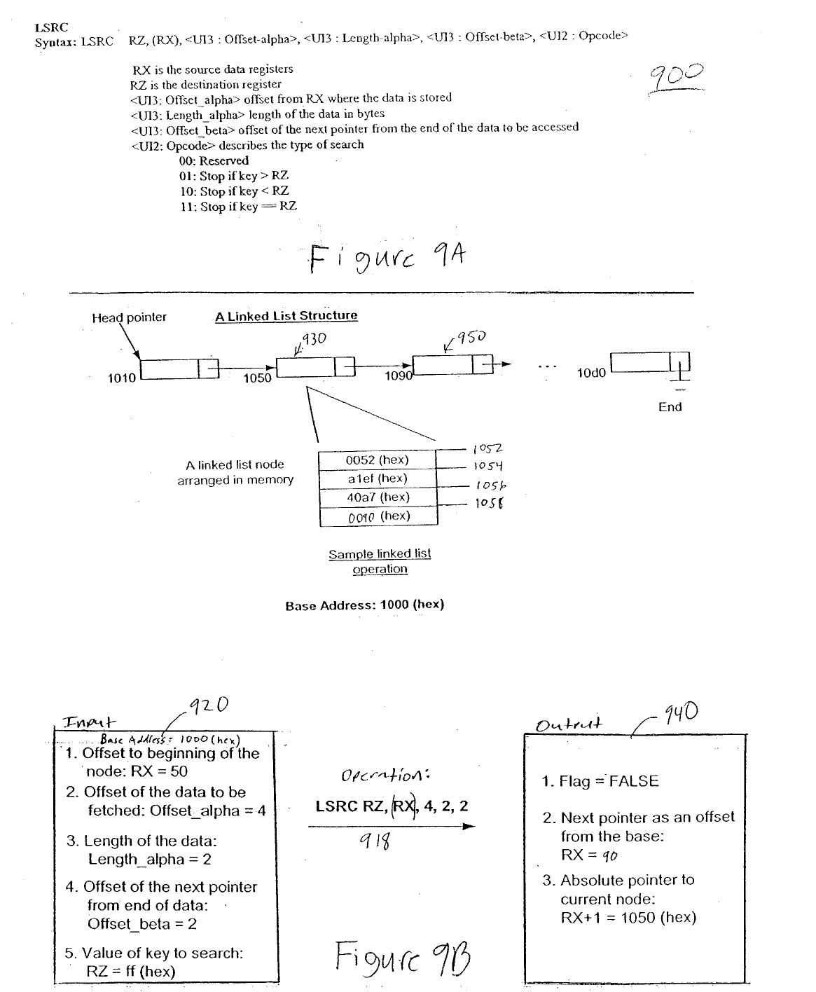

Turning now to FIG. 9A, FIG. 9A illustrates a LSRC (i.e. link search) instruction 900 of the data structure traversal ISA according to one embodiment of the invention. Basically, the LSRC (i.e. link search) instruction 900 searches for a given key value in a node of a linked list defined in memory. As shown in FIG. 9A, The LSRC (i.e. link search) instruction 900 has the following syntax: LSRC RZ, (RX), <UI3: Offset-alpha>, <UI3: Length-alpha>, <UI3: Offset-beta><UI2: Opcode>; where:

RX is the source data register;

RZ is the destination register;

<UI3: Offset_alpha> is the offset from RX where the data is stored;

<UI3: Length_alpha> is the length of the data in bytes;

<UI3: Offset_beta> is the offset of the next pointer from the end of the data to be accessed; and

<UI2: Opcode> describes the type of search

00: Reserved

01: Stop if key > RZ

10: Stop if key <RZ

11: Stop if key ==RZ.

Generally, the LSRC (i.e. link search) instruction 900 takes as input, an address to a node of a linked list defined in memory and a key data to search for and returns a flag if a match was found, address to the next node, and also the current pointer. The <UI3: Offset-alpha>, <UI3: Length-alpha>, <UI3: Offset-beta>, and <U12: Opcode> parameters may be considered control parameters. Further, the addresses are usually defined as an offset from a base address, which is stored in a control register. This helps in easy relocation of the entire linked list in that the node contents can be copied over to a different area in memory and the base register can be modified to point to the new location. This relocation does not require modifying the next pointers stored in the linked list nodes.

Particularly, looking at FIG. 9B, the LSRC (i.e. link search) instruction operation: LSRC RZ, (RX), 4, 2, 2 (918) will be discussed, as an example. The inputs (block 920) are defined as follows: the base address is defined to be 1000, the offset to the beginning of the node is defined as RX=50 (i.e node address=1050) (block 930); the offset of the data to be fetched is 4 (i.e. Offset_alpha =4); the length of the data in bytes is 2 (i.e. Length_alpha =2); the offset of the next pointer from the end of the data is 2 (i.e. Offset_{—beta=}2); and the value of the key to search for is RZ=ff. The LSRC instruction operation 918 with the previously described inputs returns outputs (block 940), including: a Flag=False indicating that the key to search for, RZ=ff, did not equal the 2-byte node data alef found starting at address 1054; the 2-byte next pointer as an offset from the base fetched starting at address 1058 RX=90 (i.e. pointer 1090, block 950); and the absolute pointer to the current node, RX+1=1050 (block 930). Also, although not shown here, different types of searches can be performed by setting the <UI2: Opcode> parameter, as described above.

Further, it should be noted that an offset of zero is used to indicate the end of the list. If a match is found, the instruction returns the value zero for the next address. When the instruction is supplied with an initial pointer offset of zero, it behaves like a NOP instruction and does nothing. This helps in using the instruction in a loop effectively.

The following is an example in pseudo code showing how to use the LSRC (i.e. link search) instruction in a loop to search for an element in a linked list:

Initialize base pointer
RX = offset to first node
RZ = value of the key to be found
While (RX != 0 && flag = false)
{

/* Look for key == RZ */
LSRC RZ, (RX), 0, 2, 2, 3

}

Note: at the end of the loop execution, RX+1 if not zero, will contain the pointer to the node where a match was found.

Moreover, the previously described LSRC (i.e. link search) instruction, used to search for a given key value in a node of a linked list defined in memory, is very useful for packet processing applications. In particular, the LSRC instruction executes with one cycle throughput. In comparison, utilizing a traditional RISC instruction set, the number of cycles needed to perform the same link search functionality is around 8-11 cycles.

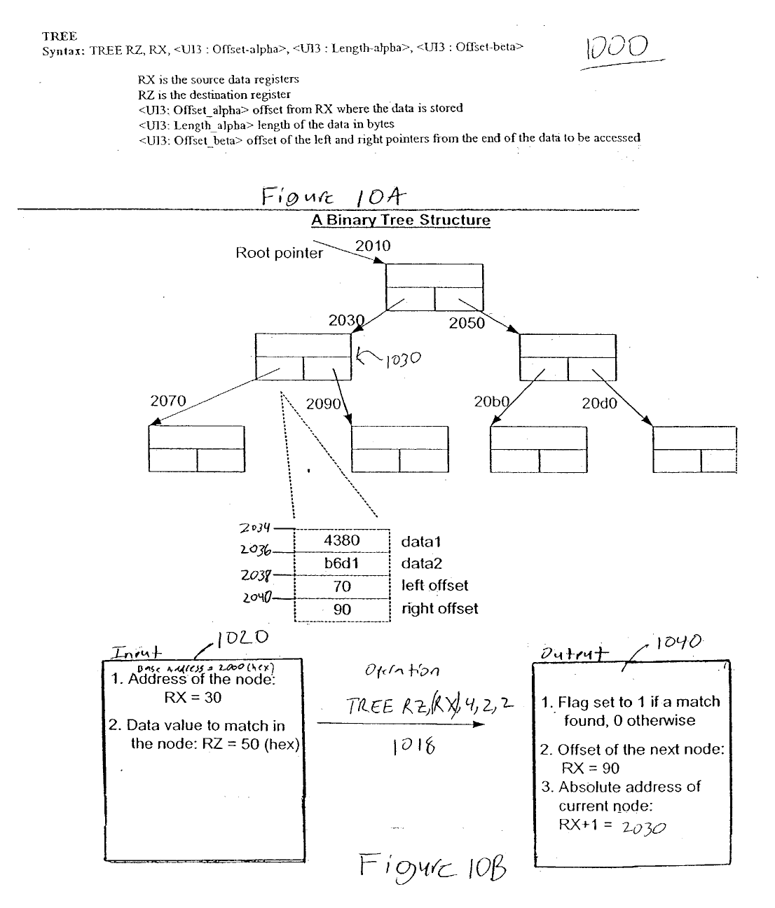

Turning now to FIG. 10A, FIG. 10A illustrates a TREE (i.e. tree search) instruction 1000 of the data structure traversal ISA according to one embodiment of the invention. Basically, the TREE search instruction 1000 is used to access a node in a binary tree in memory and to return a left or right pointer based on a key value in the node and, further, stops at a node with a matching key. As shown in FIG. 10A, the TREE instruction 1000 has the following syntax: TREE RZ, (RX), <UI3: Offset-alpha>, <UI3: Length-alpha>, <UI3: Offset-beta>; where:

RX is the source data register;

RZ is the destination register;

<UI3: Offset_alpha> is the offset from RX where the data is stored;

<UI3: Length_alpha> is the length of the data in bytes; and

<UI3: Offset_beta> is the offset of the left and right pointers from the end of the data to be accessed.

Generally, the TREE search instruction 1000 takes as input, an address to a node of a binary tree structure defined in memory and also a data value used as the key. The data value in the node is compared with the key and different address values are returned based on the result. For example:

If the key > data in the node, then a left pointer is returned; or

If the key <data in the node, then a right pointer is returned; or

If the key==data in the node, then a value of zero is returned.

In addition to the next address, the TREE instruction 1000 also returns the absolute address of the current node itself for accessing other members of the node, if a match was found. The <UI3: Offset-alpha>, <UI3: Length-alpha>, and <UI3: Offset-beta> parameters may be considered control parameters. Further, the addresses are usually defined as an offset from a base address, which is stored in a control register. Moreover, if the input address supplied is zero the instruction behaves like a NOP and does nothing.

Particularly, looking at FIG. 10B, the TREE instruction operation: TREE RZ, (RX), 4, 2, 2 (1018) will be discussed, as an example. The inputs (block 1020) are defined as follows: the base address is defined to be 2000, the offset to the beginning of the node is defined as RX=30 (i.e. node address=2030) (block 1030); the data value to be matched in the node is RZ=50; the offset from RX where the data is stored is 4 (i.e. Offset_alpha=4, node address=2034); the length of the data in bytes is 2 (i.e. Length_alpha=2); and the offset of the left and right pointers from the end of the data to be accessed is 2 (i.e. Offset_beta=2). The TREE instruction operation 1018 with the previously described inputs returns outputs (block 1040), including a Flag set 1 if a match is not found, and 0 otherwise. In this example, the key, 50, is found to be less than the data in the node, 4380, (fetched starting at address 2034) so the right offset pointer (fetched starting at address 2040) is returned such that the offset of the next node is RX=90 (i.e. node address=2090). Further, the absolute address of the current node RX+1 is returned as 2030.

The following is an example in pseudo code showing how to use the TREE instruction in traversing a tree and searching for a data value:

Initialize base pointer
RX = offset to first node
RZ = value of the key to be found
While (RX != 0)
{

TREE RZ, (RX), 4, 2, 2

}

Note: at the end of the loop execution, RX+1, if not zero, will now contain the pointer to node where a match was found

Moreover, the previously described TREE instruction, used to access a node in a binary tree in memory and to return a left or right pointer based on a key value in the node and to further stop at a node with a matching key, is very useful for packet processing applications. In particular, the TREE search instruction executes with one cycle throughput. In comparison, utilizing a traditional RISC instruction set, the number of cycles needed to perform the same TREE searching functionality is around 5-8 cycles.

The previously described data structure traversal instructions provide significant advantages over traditional RISC instructions in that these novel and non-obvious data structure traversal instructions significantly reduce the number of cycles required to achieve the desired functionality as compared to traditional RISC instructions.

Specifically:

1. The previously described PNTR (i.e. pointer) instruction, used to access a node in a linked list defined in memory and to return a data field and the next address, is very useful for packet processing applications. In particular, the PNTR instruction executes with one cycle throughput, whereas, utilizing a traditional RISC instruction set, the number of cycles needed to perform the same pointer functionality is around 5-8 cycles.

2. The previously described LSRC (i.e. link search) instruction, used to searches for a given key value in a node of a linked list defined in memory, is likewise very useful for packet processing applications. In particular, the LSRC instruction executes with one cycle throughput, whereas, utilizing a traditional RISC instruction set, the number of cycles needed to perform the same link search functionality is around 8-11 cycles.

3. The previously described TREE search instruction, used to access a node in a binary tree in memory and to return a left or right pointer based on a key value in the node and to further stop at a node with a matching key, is similarly very useful for packet processing applications. In particular, the TREE instruction executes with one cycle throughput, whereas, utilizing a traditional RISC instruction set, the number of cycles needed to perform the same TREE searching functionality is around 5-8 cycles.

4. Further, the NOP feature allows the instruction to be a part of an unconditional loop. That is, the loop containing the instruction can be executed an arbitrary number of times without checking if the key has been matched. In addition, the instructions also result in code compression (i.e. the number of instructions needed to execute the target functionality).

These cycle count reductions directly improve performance for common subtasks in packet processing (e.g. voice packet processing), such as header creation and parsing, error detection, jitter processing resulting in an approximate 4 to 8 time improvement in processing speed, for the instruction set as a whole, compared to a typical RISC processor. Thus, the data structure traversal instructions according to embodiments of the invention can be used to help build high performance packet processors (e.g. voice packet processor) for use in muli-service access devices, switches, routers, or any type of computing device, etc., to therefore support higher densities of packet flows (e.g. voice flows). Use of the data structure traversal instructions according to embodiments of the invention can enable hardware (e.g. packet processors) to be built that require less area and power on an associated board and that can be built at a lower cost.

Those skilled in the art will recognize that although aspects of the invention and various functional components have been described in particular embodiments, it should be appreciated these aspects and functionalities can be implemented in hardware, software, firmware, middleware or a combination thereof.

When implemented in software, firmware, or middleware, the elements of the present invention are the instructions/code segments to perform the necessary tasks. The instructions which when read and executed by a machine or processor, cause the machine processor to perform the operations necessary to implement and/or use embodiments of the invention. As illustrative examples, the “machine” or “processor” may include a digital signal processor, a microcontroller, a state machine, or even a central processing unit having any type of architecture, such as complex instruction set computers (CISC), reduced instruction set computers (RISC), very long instruction work (VLIW), or hybrid architecture. These instructions can be stored in a machine readable medium (e.g. a processor readable medium or a computer program product) or transmitted by a computer data signal embodied in a carrier wave, or a signal modulated by a carrier, over a transmission medium of communication link. The machine-readable medium may include any medium that can store or transfer information in a form readable and executable by a machine. Examples of the machine readable medium include an electronic circuit, a semiconductor memory device, a ROM, a flash memory, an erasable programmable ROM (EPROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via networks such as the Internet, Intranet, etc.

While embodiments of the invention have been described with reference to illustrative embodiments, these descriptions are not intended to be construed in a limiting sense. Various modifications of the illustrative embodiments, as well as other embodiments of the invention, which are apparent to persons skilled in the art to which embodiments of the invention pertain, are deemed to lie within the spirit and scope of the invention.

What is claimed is:

1. An instruction set architecture (ISA) comprising:
a data structure traversal instruction for use in packet processing, the data structure traversal instruction including a control; and
in response to the control, the data structure traversal instruction to traverse a data structure to access at least one node of the data structure.

2. The ISA of claim 1, wherein the data structure includes at least one of a linked list and a binary tree.

3. The ISA of claim 1, wherein the data structure traversal instruction for packet processing is implemented in a packet processor.

4. The ISA of claim 1, wherein the data structure traversal instruction includes a pointer instruction.

5. The ISA of claim 4, wherein the pointer instruction accesses a node in a linked list and returns a data field and a next address.

6. The ISA claim 1, wherein the data structure traversal instruction includes a link search instruction.

7. The ISA of claim 6, wherein the link search instruction searches for a key value in a node of a linked list and returns a flag if a match is found.

8. The ISA of claim 1, wherein the data structure traversal instruction includes a tree search instruction.

9. The ISA of claim 8, wherein the tree search instruction searches a binary tree for a node with a matching key, and if a matching key is found, the tree searching instruction stops.

10. The ISA of claim 9, wherein if a matching key is not found in the node, a left or right pointer is returned.

11. A packet processor comprising:
a packet processor core to implement an instruction set architecture including a data structure traversal instruction for use in packet processing, the data structure traversal instruction including a control; and
in response to the control of the data structure traversal instruction, the packet processor core to traverse a data structure to access at least one node of the data structure.

12. The packet processor of claim 11, wherein the data structure includes at least one of a linked list and a binary tree.

13. The packet processor of claim 11, wherein the data structure traversal instruction includes a pointer instruction.

14. The packet processor of claim 13, wherein the pointer instruction instructs the packet processor core to accesses a node in a linked list and returns a data field and a next address.

15. The packet processor claim 11, wherein the data structure traversal instruction includes a link search instruction.

16. The packet processor of claim 15, wherein the link search instruction instructs the packet processor core to search for a key value in a node of a linked list and returns a flag if a match is found.

17. The packet processor of claim 11, wherein the data structure traversal instruction includes a tree search instruction.

18. The packet processor of claim 17, wherein the tree search instruction instructs the packet processor core to search a binary tree for a node with a matching key, and if a matching key is found, the tree searching instruction stops.

19. The packet processor of claim 18, wherein if a matching key is not found in the node, a left or right pointer is returned.

20. A method comprising:
providing a data structure traversal instruction for use in packet processing; and
providing a control to the data structure traversal instruction, the data structure traversal instruction in response to the control to:
traverse a data structure; and
access at least one node of the data structure.

21. The method of claim 20, wherein the data structure includes at least one of a linked list and a binary tree.

22. The method of claim 20, further comprising:
accessing a node in a linked list; and
returning a data field and a next address.

23. The method of claim 20, further comprising:
searching for a key value in a node of a linked list; and returning a flag if a match is found.

24. The method of claim 20, further comprising:
searching a binary tree for a node with a matching key, and if a matching key is found;
stopping the tree search.

25. The method of claim 24, wherein if a matching key is not found in the node, a left or right pointer is returned.

26. A machine-readable medium having stored thereon a data structure traversal instruction including a control for use in packet processing, which when executed by a packet processor, causes the packet processor to perform the following operations:
in response to the control,
traversing a data structure; and
accessing at least one node of the data structure.

27. The machine-readable medium of claim 26, wherein the data structure includes at least one of a linked list and a binary tree.

28. The machine-readable medium of claim 26, wherein the data structure traversal instruction for packet processing is implemented in a packet processor core.

29. The machine-readable medium of claim 26, wherein the data structure traversal instruction includes a pointer instruction.

30. The machine-readable medium of claim 29, wherein the pointer instruction accesses a node in a linked list and returns a data field and a next address.

31. The machine-readable medium claim 26, wherein the data structure traversal instruction includes a link search instruction.

32. The machine-readable medium of claim 31, wherein the link search instruction searches for a key value in a node of a linked list and returns a flag if a match is found.

33. The machine-readable medium of claim 26, wherein the data structure traversal instruction includes a tree search instruction.

34. The machine-readable medium of claim 33, wherein the tree search instruction searches a binary tree for a node with a matching key, and if a matching key is found, the tree searching instruction stops.

35. The machine-readable medium of claim 34, wherein if a matching key is not found in the node, a left or right pointer is returned.

36. A system comprising:
a network device coupling a first network to a second network, the network device having a packet processor that includes:
a packet processor core to implement an instruction set architecture including a data structure traversal instruction for use in packet processing, the data structure traversal instruction including a control; and
in response to the control of the data structure traversal instruction, the packet processor core traverses a data structure to access at least one node of the data structure.

37. The system of claim 36, wherein the data structure includes at least one of a linked list and a binary tree.

38. The system of claim 36, wherein the data structure traversal instruction includes a pointer instruction.

39. The system of claim 38, wherein the pointer instruction instructs the packet processor core to accesses a node in a linked list and returns a data field and a next address.

40. The system claim 36, wherein the data structure traversal instruction includes a link search instruction.

41. The system of claim 40, wherein the link search instruction instructs the packet processor core to search for a key value in a node of a linked list and returns a flag if a match is found.

42. The system of claim 36, wherein the data structure traversal instruction includes a tree search instruction.

43. The system of claim 42, wherein the tree search instruction instructs the packet processor core to search a binary tree for a node with a matching key, and if a matching key is found, the tree searching instruction stops.

44. The system of claim 43, wherein if a matching key is not found in the node, a left or right pointer is returned.
